(19) United States
(12) Patent Application Publication
(10) Pub. No.: US 2013/0261234 A1
(43) Pub. Date: Oct. 3, 2013

(54) Flame Retardant Polycarbonate Composition with High Pencil Hardness

(71) Applicant: Shiping MA, Tochigi-ken (JP)

(72) Inventor: Shiping MA, Tochigi-ken (JP)

(21) Appl. No.: 13/436,224

(22) Filed: Mar. 30, 2012

(51) Int. Cl. C08L 69/00; C08L 83/00; C08K 5/5313; C08K 3/36; C08K 5/54

(52) U.S. Cl. 524/126; 524/502; 524/493; 524/81

(57) ABSTRACT

Flame retardant polycarbonate compositions that exhibit a balance of impact resistance, heat resistance, and pencil hardness.

### TECHNICAL FIELD

The present disclosure relates to flame retardant polycarbonate compositions having high pencil hardness.

### TECHNICAL BACKGROUND

Modern polycarbonate compositions can be manufactured to exhibit good impact resistance, heat resistance, and flame retardancy, but these materials typically exhibit poor pencil hardness. Poly(methylmethacrylates) can be added to polycarbonate materials to improve pencil hardness, but such improvements are only achieved with a significant loss in flame resistance.

Therefore, there is a need for flame retardant polycarbonate materials having improved pencil hardness, and that retain a good impact resistance, heat resistance, and flame retardant properties. These needs and other needs are satisfied by the compositions and methods of the present disclosure.

### SUMMARY

In accordance with the purpose(s) of the invention, as embodied and broadly described herein, this disclosure, in one aspect, relates to flame retardant polycarbonate compositions, and specifically to phosphorus free flame retardant polycarbonate compositions.

In one aspect, the present disclosure provides a composition comprising from about 0.5 wt. % to about 99.5 wt. % of a first polymer component comprising a polycarbonate, a silicone-polycarbonate copolymer, or a combination thereof; a fine silica; from about 0 wt. % to about 30 wt. % of a second polymer component comprising an acrylonitrile-butadiene-styrene, an acrylonitrile-ethylene-styrene, a poly(methylmethacrylate), or a combination thereof; and from about 0.5 wt. % to about 25 wt. % of a flame retardant additive.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited.

### DEFINITIONS

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, example methods and materials are now described.

As used in the specification and the appended claims, the singular forms “a,” “an” and “the” include plural referents unless the context clearly dictates otherwise. Thus, for example, reference to “a ketone” includes mixtures of two or more ketones.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or can not occur, and that the description includes instances where said event or circumstance occurs and instances where it does not. For example, the phrase “optionally substituted alkyl” means that the alkyl group can or can not be substituted and that the description includes both substituted and unsubstituted alkyl groups.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific aspect or combination of aspects of the methods of the invention.

References in the specification and concluding claims to parts by weight, of a particular element or component in a composition or article, denote the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included.

A residue of a chemical species, as used in the specification and concluding claims, refers to the moiety that is the resulting product of the chemical species in a particular reaction scheme or subsequent formulation or chemical product, regardless of whether the moiety is actually obtained from the chemical species. Thus, an ethylene glycol residue in a polyester refers to one or more —OCH₂CH₂O— units in the polyester, regardless of whether ethylene glycol was used to prepare the polyester. Similarly, a sebacic acid residue in a polyester refers to one or more —CO(CH₂)₈CO— moieties in the polyester, regardless of whether the residue is obtained by reacting sebacic acid or an ester thereof to obtain the polyester.

The term “alkyl group” as used herein is a branched or unbranched saturated hydrocarbon group of 1 to 24 carbon atoms, such as methyl, ethyl, n-propyl, isopropyl, n-butyl, isobutyl, t-butyl, pentyl, hexyl, heptyl, octyl, decyl, tetradecyl, hexadecyl, eicosyl, tetracosyl and the like. A “lower alkyl” group is an alkyl group containing from one to six carbon atoms.

The term “alkoxy” as used herein is an alkyl group bound through a single, terminal ether linkage; that is, an “alkoxy” group can be defined as —OR where R is alkyl as defined above. A “lower alkoxy” group is an alkoxy group containing from one to six carbon atoms.

The term “alkenyl group” as used herein is a hydrocarbon group of from 2 to 24 carbon atoms and structural formula containing at least one carbon-carbon double bond. Asymmetric structures such as (AB)C=C(CD) are intended to include both the E and Z isomers. This can be presumed in structural formulae herein wherein an asymmetric alkene is present, or it can be explicitly indicated by the bond symbol C.

The term “alkynyl group” as used herein is a hydrocarbon group of 2 to 24 carbon atoms and a structural formula containing at least one carbon-carbon triple bond.

The term “aryl group” as used herein is any carbon-based aromatic group including, but not limited to, benzene, naphthalene, etc. The term “aromatic” also includes “heteroaryl group,” which is defined as an aromatic group that has at least one heteroatom incorporated within the ring of the aromatic group. Examples of heteroatoms include, but are not limited to, nitrogen, oxygen, sulfur, and phosphorus. The aryl group can be substituted or unsubstituted. The aryl group can be substituted with one or more groups including, but not limited to, alkyl, alkynyl, alkenyl, aryl, halide, nitro, amino, ester, ketone, aldehyde, hydroxy, carboxylic acid, or alkoxy.

The term “cycloalkyl group” as used herein is a non-aromatic carbon-based ring composed of at least three carbon atoms. Examples of cycloalkyl groups include, but are not limited to, cyclopropyl, cyclobutyl, cyclopentyl, cyclohexyl, etc. The term “heterocycloalkyl group” is a cycloalkyl group as defined above where at least one of the carbon atoms of the ring is substituted with a heteroatom such as, but not limited to, nitrogen, oxygen, sulphur, or phosphorus.

The term “aralkyl” as used herein is an aryl group having an alkyl, alkynyl, or alkenyl group as defined above attached to the aromatic group. An example of an aralkyl group is a benzyl group.

The term “hydroxyalkyl group” as used herein is an alkyl, alkenyl, alkynyl, aryl, aralkyl, cycloalkyl, halogenated alkyl, or heterocycloalkyl group described above that has at least one hydrogen atom substituted with a hydroxyl group.

The term “alkoxyalkyl group” is defined as an alkyl, alkenyl, alkynyl, aryl, aralkyl, cycloalkyl, halogenated alkyl, or heterocycloalkyl group described above that has at least one hydrogen atom substituted with an alkoxy group described above.

The term “ester” as used herein is represented by the formula —C(O)OA, where A can be an alkyl, halogenated alkyl, alkenyl, alkynyl, aryl, heteroaryl, cycloalkyl, cycloalkenyl, heterocycloalkyl, or heterocycloalkenyl group described above.

The term “carbonate group” as used herein is represented by the formula —OC(O)OR, where R can be hydrogen, an alkyl, alkenyl, alkynyl, aryl, aralkyl, cycloalkyl, halogenated alkyl, or heterocycloalkyl group described above.

The term “carboxylic acid” as used herein is represented by the formula —C(O)OH.

The term “aldehyde” as used herein is represented by the formula —C(O)H.

The term “keto group” as used herein is represented by the formula —C(O)R, where R is an alkyl, alkenyl, alkynyl, aryl, aralkyl, cycloalkyl, halogenated alkyl, or heterocycloalkyl group described above.

The term “carbonyl group” as used herein is represented by the formula C═O.

The term “ether” as used herein is represented by the formula AOA¹, where A and A¹ can be, independently, an alkyl, halogenated alkyl, alkenyl, alkynyl, aryl, heteroaryl, cycloalkyl, cycloalkenyl, heterocycloalkyl, or heterocycloalkenyl group described above.

The term “sulfo-oxo group” as used herein is represented by the formulas —S(O)₂R, —OS(O)₂R, or, —OS(O)₂OR, where R can be hydrogen, an alkyl, alkenyl, alkynyl, aryl, aralkyl, cycloalkyl, halogenated alkyl, or heterocycloalkyl group described above.

Unless specifically stated to the contrary, terms for components and materials used throughout the specification are listed in Table 1, below, together with a description and source.

TABLE 1
Raw materials used.

| Component | Description |
|---|---|
| PC-ST | Polysiloxane-polycarbonate copolymer comprising units |
| | derived from BPA and dimethylsiloxane. The |
| | dimethylsiloxane content is 20 wt. % |
| Si-PC | Silicone-polycarbonate copolymer |
| AEROSIL 200 | Nano sized silica having first order particle size of about |
| (A200) | 12 nm, wherein the surface is covered with silanol groups |
| RX200 | Nano sized silica having first order particle size of about |
| | 12 nm, wherein the surface is covered with trimethyl |
| | groups |
| BPADP | Bisphenol A diphenyl phosphate |
| MBS | Nominal 75-82 wt. % butadiene core with a balance |
| | styrene-methyl methacrylate shell, available under the |
| | tradename EXL-2691-A. |
| Metablen | Core-shell impact modifier (core: silicone elastomer) & |
| (SX005) | (shell: MMA copolymer) available under the tradename |
| | SX-005 |
| ABS | Acrylonitrile-butadiene-styrene |
| AES | Acrylonitrile-ethylene-styrene |
| PMMA | Poly(methylmethacrylate) |
| SAN | Styrene-acrylonitrile copolymer |
| BPA | Bisphenol A |
| TSAN | Polytetrafluoroethylene (PTFE) encapsulated by a |
| | styrene = acrylonitrile copolymer (SAN) (anti-drip agent) |

Each of the materials disclosed herein are either commercially available and/or the methods for the production thereof are known to those of skill in the art. For example, PC-ST and TSAN are available from SABIC Innovative Plastics, BDADP is available from Supresta, MBS is available from Rohm & Haas, and Metablen SX005 is available from Mitsubishi Rayon Co., Ltd.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

As briefly described above, the present disclosure provides flame retardant polycarbonate materials having high pencil hardness. Conventional polycarbonate materials can be manufactured to provide good flame retardance, heat resistance, and impact resistance, but these materials generally exhibit poor (i.e., weak) pencil hardness. Poly(methylmethacrylate) (PMMA) can be added to the polycarbonate compositions to improve pencil hardness, but will result in a significant loss in flame retardancy. In various aspects, the present disclosure provides flame retardant polymer compositions comprising a first polymer component, a fine particle silica, a second polymer component, and a flame retardant additive.

### First Polymer Component

The first polymer component of the present invention can comprise a polycarbonate component, a silicone-polycarbonate copolymer component, or a combination thereof. In various aspects, the first polymer component can comprise from about 0.5 wt. % to about 99.5 wt. % of the inventive composition, for example, about 0.5, 1, 2, 3, 4, 5, 6, 7, 8, 9, 10, 15, 20, 25, 30, 35, 40, 45, 50, 55, 60, 65, 70, 75, 80, 85, 90, 95, 97, 98, 99, or 99.5 wt. % of the inventive composition. In another aspect, the first polymer component can comprise from about 50 wt. % to about 75 wt. %, for example, about 50, 52, 54, 56, 58, 60, 62, 64, 66, 68, 70, 72, 74, or 75 wt. % of the inventive composition. In another aspect, if a silicone-polycarbonate copolymer is used, it can comprise any portion of or all of the first polymer component. In another aspect, a silicone-polycarbonate component, if used, can comprise up to about 15 wt. % of the inventive composition, for example, about 0.5, 1, 2, 3, 4, 5, 6, 7, 8, 10, 12, 14, or 15 wt. % of the inventive composition.

In one aspect, the first polymer component comprises a polycarbonate. In various aspects, the polycarbonate can have useful mechanical properties such as impact strength and transparency. In other aspects, the polycarbonate can optionally have low background color, good UV stability, and good molecular weight (Mw) stability. In still other aspects, all or a portion of the polycarbonate can be derived from or prepared from natural and/or renewable materials.

As used herein, the term “polycarbonate” includes homopolycarbonates and copolycarbonates have repeating structural carbonate units. In one aspect, a polycarbonate can comprise any polycarbonate material or mixture of materials as recited in U.S. Pat. No. 7,786,246, which is hereby incorporated in its entirety for the specific purpose of disclosing various polycarbonate compositions and methods.

In one aspect, a polycarbonate, as disclosed herein, can be an aliphatic-diol based polycarbonate. In another aspect, a polycarbonate can comprise a carbonate unit derived from a dihydroxy compound, such as for example a bisphenol that differs from the aliphatic diol.

In one aspect, non-limiting examples of suitable bisphenol compounds include the following: 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(hydroxyphenyl)cyclopentane, 1,1-bis(4-hydroxyphenyl)cyclohexane, 1,1-bis(4-hydroxy-3 methylphenyl)cyclohexane 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantine, (alpha,alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorene, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, and the like, as well as combinations comprising at least one of the foregoing dihydroxy aromatic compounds.

In another aspect, exemplary bisphenol compounds can comprise 1,1-bis(4-hydroxyphenyl)methane, 1,1-bis(4-hydroxyphenyl)ethane, 2,2-bis(4-hydroxyphenyl)propane (hereinafter “bisphenol A” or “BPA”), 2,2-bis(4-hydroxyphenyl)butane, 2,2-bis(4-hydroxyphenyl)octane, 1,1-bis(4-hydroxyphenyl)propane, 1,1-bis(4-hydroxyphenyl)n-butane, 2,2-bis(4-hydroxy-1-methylphenyl)propane, 1,1-bis(4-hydroxy-t-butylphenyl)propane, 3,3-bis(4-hydroxyphenyl)phthalimidine, 2-phenyl-3,3-bis(4-hydroxyphenyl)phthalimidine (“PPPBP”), and 9,9-bis(4-hydroxyphenyl)fluorene. Combinations comprising at least one dihydroxy aromatic compound can also be used. In another aspect, other types of diols can be present in the polycarbonate.

In yet another aspect, polycarbonates with branching groups are can be useful, provided that such branching does not significantly adversely affect desired properties of the polycarbonate. Branched polycarbonate blocks can be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl)alpha,alpha-dimethylbenzyl)phenol), 4-chloroformyl phthalic anhydride, trimesic acid, and benzophenone tetracarboxylic acid. In one aspect, a branching agent can be added at a level of about 0.05 to about 2.0 wt %. In still another aspect, mixtures comprising linear polycarbonates and branched polycarbonates can be used.

Polycarbonates can comprise copolymers comprising carbonate units and other types of polymer units, including ester units, and combinations comprising at least one of homopolycarbonates and copolycarbonates. An exemplary polycarbonate copolymer of this type is a polyester carbonate, also known as a polyester-polycarbonate. Such copolymers further contain carbonate units derived from oligomeric ester-containing dihydroxy compounds (also referred to herein as hydroxy end-capped oligomeric acrylate esters). In another aspect, the polycarbonate component does not comprise a separate polymer such as a polyester.

In one aspect, an aliphatic-based polycarbonate comprises aliphatic units that are either aliphatic carbonate units derived from aliphatic diols, or a combination of aliphatic ester units derived from aliphatic diacids having greater than 13 carbons.

In one aspect, the molecular weight of any particular polycarbonate can be determined by, for example, gel permeation chromatography using universal calibration methods based on polystyrene (PS) standards. Generally polycarbonates can have a weight average molecular weight (Mw), of greater than about 5,000 g/mol based on PS standards. In one aspect, the polycarbonates can have an Mw of greater than or equal to about 39,000 g/mol, based on PS standards. In another aspect, the polycarbonates have an Mw based on PS standards of 39,000 to 100,000 g/mol, specifically 40,000 to 90,000 g/mol, more specifically 40,000 to 80,000 g/mol, and still more specifically 40,000 to 70,000 g/mol. In another aspect, the polycarbonates have an Mw based on polycarbonate (PC) standards of 20,000 to 70,000 g/mol, specifically 21,000 to 65,000 g/mol, more specifically 22,000 to 60,000 g/mol, and still more specifically 25,000 to 60,000 g/mol.

Molecular weight (Mw and Mn) as described herein, and polydispersity as calculated therefrom, can be determined using gel permeation chromatography (GPC), using a crosslinked styrene-divinylbenzene column, and either PS or PC standards as specified. GPC samples can be prepared in a solvent such as methylene chloride or chloroform at a concentration of about 1 mg/ml, and can be eluted at a flow rate of about 0.2 to 1.0 ml/min.

In one aspect, the glass transition temperature (T_{g}) of a polycarbonate can be less than or equal to 135° C. In another aspect, the glass transition temperature of a polycarbonate can be from about 85° C. to about 130° C., from about 90° C. to about 130° C., from about 90° C. to about 125° C., or from about 90° C. to about 120° C.

In one aspect, polycarbonates can be manufactured using an interfacial phase transfer process or melt polymerization. Although the reaction conditions for interfacial polymerization can vary, an exemplary process generally involves dissolving or dispersing a dihydric phenol reactant in aqueous caustic soda or potash, adding the resulting mixture to a water-immiscible solvent medium such as for example methylene chloride, and contacting the reactants with a carbonate precursor (such as phosgene) in the presence of a catalyst such as, for example, triethylamine or a phase transfer catalyst salt, under controlled pH conditions of, for example, about 8 to about 10.

The polycarbonate can, in various aspects, be prepared by a melt polymerization process. Generally, in the melt polymerization process, polycarbonates are prepared by co-reacting, in a molten state, the dihydroxy reactant(s) and a diaryl carbonate ester, such as diphenyl carbonate, or more specifically in an aspect, an activated carbonate such as bis(methyl salicyl)carbonate, in the presence of a transesterification catalyst. The reaction can be carried out in typical polymerization equipment, such as one or more continuously stirred reactors (CSTRs), plug flow reactors, wire wetting fall polymerizers, free fall polymerizers, wiped film polymerizers, BANBURY® mixers, single or twin screw extruders, or combinations of the foregoing. In one aspect, volatile monohydric phenol can be removed from the molten reactants by distillation and the polymer is isolated as a molten residue. In another aspect, a useful melt process for making polycarbonates utilizes a diaryl carbonate ester having electron-withdrawing substituents on the aryls. Examples of specifically useful diaryl carbonate esters with electron withdrawing substituents include bis(4-nitrophenyl)carbonate, bis(2-chlorophenyl)carbonate, bis(4-chlorophenyl)carbonate, bis(methyl salicyl)carbonate, bis(4-methylcarboxylphenyl)carbonate, bis(2-acetylphenyl)carboxylate, bis(4-acetylphenyl)carboxylate, or a combination comprising at least one of the foregoing.

The melt polymerization can include a transesterification catalyst comprising a first catalyst, also referred to herein as an alpha catalyst, comprising a metal cation and an anion. In one aspect, the cation is an alkali or alkaline earth metal comprising Li, Na, K, Cs, Rb, Mg, Ca, Ba, Sr, or a combination comprising at least one of the foregoing. The anion is hydroxide (OH⁻), superoxide (O²⁻), thiolate (HS⁻), sulfide (S²⁻), a C₁₋₂₀ alkoxide, a C₆₋₂₀ aryloxide, a C₁₋₂₀ carboxylate, a phosphate including biphosphate, a C₁₋₂₀ phosphonate, a sulfate including bisulfate, sulfites including bisulfites and metabisulfites, a C₁₋₂₀ sulfonate, a carbonate including bicarbonate, or a combination comprising at least one of the foregoing. In another aspect, salts of an organic acid comprising both alkaline earth metal ions and alkali metal ions can also be used. Salts of organic acids useful as catalysts are illustrated by alkali metal and alkaline earth metal salts of formic acid, acetic acid, stearic acid and ethyelenediamine tetraacetic acid. The catalyst can also comprise the salt of a non-volatile inorganic acid. By “nonvolatile”, it is meant that the referenced compounds have no appreciable vapor pressure at ambient temperature and pressure. In particular, these compounds are not volatile at temperatures at which melt polymerizations of polycarbonate are typically conducted. The salts of nonvolatile acids are alkali metal salts of phosphites; alkaline earth metal salts of phosphites; alkali metal salts of phosphates; and alkaline earth metal salts of phosphates. Exemplary transesterification catalysts include, lithium hydroxide, sodium hydroxide, potassium hydroxide, cesium hydroxide, magnesium hydroxide, calcium hydroxide, barium hydroxide, lithium formate, sodium formate, potassium formate, cesium formate, lithium acetate, sodium acetate, potassium acetate, lithium carbonate, sodium carbonate, potassium carbonate, lithium methoxide, sodium methoxide, potassium methoxide, lithium ethoxide, sodium ethoxide, potassium ethoxide, lithium phenoxide, sodium phenoxide, potassium phenoxide, sodium sulfate, potassium sulfate, NaH₂PO₃, NaH₂PO₄, Na₂H₂PO₃, KH₂PO₄, CsH₂PO₄, Cs₂H₂PO₄, Na₂SO₃, Na₂S₂O₅, sodium mesylate, potassium mesylate, sodium tosylate, potassium tosylate, magnesium disodium ethylenediamine tetraacetate (EDTA magnesium disodium salt), or a combination comprising at least one of the foregoing. It will be understood that the foregoing list is exemplary and should not be considered as limited thereto. In one aspect, the transesterification catalyst is an alpha catalyst comprising an alkali or alkaline earth salt. In an exemplary aspect, the transesterification catalyst comprising sodium hydroxide, potassium hydroxide, sodium carbonate, potassium carbonate, sodium methoxide, potassium methoxide, NaH₂PO₄, or a combination comprising at least one of the foregoing.

The amount of alpha catalyst can vary widely according to the conditions of the melt polymerization, and can be about 0.001 to about 500 μmol. In an aspect, the amount of alpha catalyst can be about 0.01 to about 20 μmol, specifically about 0.1 to about 10 μmol, more specifically about 0.5 to about 9 μmol, and still more specifically about 1 to about 7 μmol, per mole of aliphatic diol and any other dihydroxy compound present in the melt polymerization.

In another aspect, a second transesterification catalyst, also referred to herein as a beta catalyst, can optionally be included in the melt polymerization process, provided that the inclusion of such a second transesterification catalyst does not significantly adversely affect the desirable properties of the polycarbonate. Exemplary transesterification catalysts can further include a combination of a phase transfer catalyst of formula (R³)₄Q⁺X above, wherein each R³ is the same or different, and is a C₁₋₁₀ alkyl group; Q is a nitrogen or phosphorus atom; and X is a halogen atom or a C₁₋₈ alkoxy group or C₆₋₁₈ aryloxy group. Exemplary phase transfer catalyst salts include, for example, [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX, CH₃[CH₃(CH₂)₃]₃NX, and CH₃[CH₃(CH₂)₂]₃NX, wherein X is Cl⁻, Br⁻, a C₁₋₈ alkoxy group or a C₆₋₁₈ aryloxy group. Examples of such transesterification catalysts include tetrabutylammonium hydroxide, methyltributylammonium hydroxide, tetrabutylammonium acetate, tetrabutylphosphonium hydroxide, tetrabutylphosphonium acetate, tetrabutylphosphonium phenolate, or a combination comprising at least one of the foregoing. Other melt transesterification catalysts include alkaline earth metal salts or alkali metal salts. In various aspects, where a beta catalyst is desired, the beta catalyst can be present in a molar ratio, relative to the alpha catalyst, of less than or equal to 10, specifically less than or equal to 5, more specifically less than or equal to 1, and still more specifically less than or equal to 0.5. In other aspects, the melt polymerization reaction disclosed herein uses only an alpha catalyst as described hereinabove, and is substantially free of any beta catalyst. As defined herein, “substantially free of” can mean where the beta catalyst has been excluded from the melt polymerization reaction. In one aspect, the beta catalyst is present in an amount of less than about 10 ppm, specifically less than 1 ppm, more specifically less than about 0.1 ppm, more specifically less than or equal to about 0.01 ppm, and more specifically less than or equal to about 0.001 ppm, based on the total weight of all components used in the melt polymerization reaction.

In one aspect, a melt process employing an activated carbonate is utilized. As used herein, the term “activated carbonate”, is defined as a diarylcarbonate that is more reactive than diphenylcarbonate in transesterification reactions. Specific non-limiting examples of activated carbonates include bis(o-methoxycarbonylphenyl)carbonate, bis(o-chlorophenyl)carbonate, bis(o-nitrophenyl)carbonate, bis(o-acetylphenyl)carbonate, bis(o-phenylketonephenyl)carbonate, bis(o-formylphenyl)carbonate.

Examples of specific ester-substituted diarylcarbonates include, but are not limited to, bis(methylsalicyl)carbonate (CAS Registry No. 82091-12-1) (also known as BMSC or bis(o-methoxycarbonylphenyl)carbonate), bis(ethylsalicyl)carbonate, bis(propylsalicyl)carbonate, bis(butylsalicyl)carbonate, bis(benzylsalicyl)carbonate, bis(methyl-4-chlorosalicyl)carbonate and the like. In one aspect, bis(methylsalicyl)carbonate is used as the activated carbonate in melt polycarbonate synthesis due to its lower molecular weight and higher vapor pressure.

Some non-limiting examples of non-activating groups which, when present in an ortho position, would not be expected to result in activated carbonates are alkyl, cycloalkyl or cyano groups. Some specific and non-limiting examples of non-activated carbonates are bis(o-methylphenyl)carbonate, bis(p-cumylphenyl)carbonate, bis(p-(1,1,3,3-tetramethyl)butylphenyl)carbonate and bis(o-cyanophenyl)carbonate. Unsymmetrical combinations of these structures can also be used as non-activated carbonates.

In one aspect, an end-capping agent (also referred to as a chain-stopper) can optionally be used to limit molecular weight growth rate, and so control molecular weight in the polycarbonate. Exemplary chain-stoppers include certain monophenolic compounds (i.e., phenyl compounds having a single free hydroxy group), monocarboxylic acid chlorides, and/or monochloroformates. Phenolic chain-stoppers are exemplified by phenol and C₁-C₂₂ alkyl-substituted phenols such as p-cumyl-phenol, resorcinol monobenzoate, and p- and tertiary-butyl phenol, cresol, and monoethers of diphenols, such as p-methoxyphenol. Alkyl-substituted phenols with branched chain alkyl substituents having 8 to 9 carbon atoms can be specifically mentioned. Certain monophenolic UV absorbers can also be used as a capping agent, for example 4-substituted-2-hydroxybenzophenones and their derivatives, aryl salicylates, monoesters of diphenols such as resorcinol monobenzoate, 2-(2-hydroxyaryl)-benzotriazoles and their derivatives, 2-(2-hydroxyaryl)-1,3,5-triazines and their derivatives, and the like.

In another aspect, endgroups can be derived from the carbonyl source (i.e., the diaryl carbonate), from selection of monomer ratios, incomplete polymerization, chain scission, and the like, as well as any added end-capping groups, and can include derivatizable functional groups such as hydroxy groups, carboxylic acid groups, or the like. In one aspect, the endgroup of a polycarbonate can comprise a structural unit derived from a diaryl carbonate, where the structural unit can be an endgroup. In a further aspect, the endgroup is derived from an activated carbonate. Such endgroups can be derived from the transesterification reaction of the alkyl ester of an appropriately substituted activated carbonate, with a hydroxy group at the end of a polycarbonate polymer chain, under conditions in which the hydroxy group reacts with the ester carbonyl from the activated carbonate, instead of with the carbonate carbonyl of the activated carbonate. In this way, structural units derived from ester containing compounds or substructures derived from the activated carbonate and present in the melt polymerization reaction can form ester endgroups. In another aspect, the ester endgroup derived from a salicylic ester can be a residue of BMSC or other substituted or unsubstituted bis(alkyl salicyl)carbonate such as bis(ethyl salicyl)carbonate, bis(propyl salicyl)carbonate, bis(phenyl salicyl)carbonate, bis(benzyl salicyl)carbonate, or the like.

In one aspect, where a combination of alpha and beta catalysts are used in the melt polymerization, a polycarbonate polymer prepared from an activated carbonate can comprise endgroups in an amount of less than 2,000 ppm, less than 1,500 ppm, or less than 1,000 ppm, based on the weight of the polycarbonate. In another aspect, where only an alpha catalyst is used in the melt polymerization, a polycarbonate polymer prepared from an activated carbonate can comprise endgroups in an amount of less than or equal to 500 ppm, less than or equal to 400 ppm, less than or equal to 300 ppm, or less than or equal to 200 ppm, based on the weight of the polycarbonate.

In one aspect, the reactants for the polymerization reaction using an activated aromatic carbonate can be charged into a reactor either in the solid form or in the molten form. Initial charging of reactants into a reactor and subsequent mixing of these materials under reactive conditions for polymerization can be conducted in an inert gas atmosphere such as a nitrogen atmosphere. The charging of one or more reactants can also be done at a later stage of the polymerization reaction. Mixing of the reaction mixture is accomplished by any methods known in the art, such as by stirring. Reactive conditions include time, temperature, pressure and other factors that affect polymerization of the reactants. Typically the activated aromatic carbonate is added at a mole ratio of 0.8 to 1.3, and more preferably 0.9 to 1.3, and all subranges there between, relative to the total moles of monomer unit compounds (i.e., aromatic dihydroxy compound, and aliphatic diacid or diol). In a specific aspect, the molar ratio of activated aromatic carbonate to monomer unit compounds is 1.013 to 1.29, specifically 1.015 to 1.028. In another specific aspect, the activated aromatic carbonate is BMSC.

In one aspect, the melt polymerization reaction can be conducted by subjecting the reaction mixture to a series of temperature-pressure-time protocols. In some aspects, this involves gradually raising the reaction temperature in stages while gradually lowering the pressure in stages. In one aspect, the pressure is reduced from about atmospheric pressure at the start of the reaction to about 1 millibar (100 Pa) or lower, or in another aspect to 0.1 millibar (10 Pa) or lower in several steps as the reaction approaches completion. The temperature can be varied in a stepwise fashion beginning at a temperature of about the melting temperature of the reaction mixture and subsequently increased to final temperature. In one aspect, the reaction mixture is heated from room temperature to about 150° C. In such an aspect, the polymerization reaction starts at a temperature of about 150° C. to about 220° C. In another aspect, the polymerization temperature can be up to about 220° C. In other aspects, the polymerization reaction can then be increased to about 250° C. and then optionally further increased to a temperature of about 320° C., and all subranges there between. In one aspect, the total reaction time can be from about 30 minutes to about 200 minutes and all subranges there between. This procedure will generally ensure that the reactants react to give polycarbonates with the desired molecular weight, glass transition temperature and physical properties. The reaction proceeds to build the polycarbonate chain with production of ester-substituted alcohol by-product such as methyl salicylate. In one aspect, efficient removal of the by-product can be achieved by different techniques such as reducing the pressure. Generally the pressure starts relatively high in the beginning of the reaction and is lowered progressively throughout the reaction and temperature is raised throughout the reaction.

In one aspect, the progress of the reaction can be monitored by measuring the melt viscosity or the weight average molecular weight of the reaction mixture using techniques known in the art such as gel permeation chromatography. These properties can be measured by taking discrete samples or can be measured on-line. After the desired melt viscosity and/or molecular weight is reached, the final polycarbonate product can be isolated from the reactor in a solid or molten form. It will be appreciated by a person skilled in the art, that the method of making aliphatic homopolycarbonate and aliphatic-aromatic copolycarbonates as described in the preceding sections can be made in a batch or a continuous process and the process disclosed herein is preferably carried out in a solvent free mode. Reactors chosen should ideally be self-cleaning and should minimize any “hot spots.” However, vented extruders similar to those that are commercially available can be used.

In one aspect, the aliphatic homopolycarbonate and aliphatic-aromatic copolycarbonate can be prepared in an extruder in presence of one or more catalysts, wherein the carbonating agent is an activated aromatic carbonate. In one aspect, the reactants for the polymerization reaction can be fed to the extruder in powder or molten form. In another aspect, the reactants are dry blended prior to addition to the extruder. The extruder can be equipped with pressure reducing devices (e.g., vents), which serve to remove the activated phenol by-product and thus drive the polymerization reaction toward completion. The molecular weight of the polycarbonate product can, in various aspects, be manipulated by controlling, among other factors, the feed rate of the reactants, the type of extruder, the extruder screw design and configuration, the residence time in the extruder, the reaction temperature and the pressure reducing techniques present on the extruder. The molecular weight of the polycarbonate product can also depend upon the structures of the reactants, such as, activated aromatic carbonate, aliphatic diol, dihydroxy aromatic compound, and the catalyst employed. Many different screw designs and extruder configurations are commercially available that use single screws, double screws, vents, back flight and forward flight zones, seals, and sidestreams. One skilled in the art can find the best designs using generally known principals of commercial extruder design. Controlling the ratio diarylcarbonate/diol, specifically BMSC/diol can impact the Mw when using an activated carbonate. A lower ratio can generally give a higher molecular weight.

In one aspect, decomposition by-products of the reaction that are of low molecular weight can be removed by, for example, devolatilization during reaction and/or extrusion to reduce the amount of such volatile compounds. The volatiles typically removed can include unreacted starting diol materials, carbonate precursor materials, but are more specifically the decomposition products of the melt-polymerization reaction.

In other aspects, a polycarbonate composition can comprise one or more of an antioxidant, heat stabilizer, light stabilizer, UV absorbing additive, plasticizer, lubricant, mold release agent, antistatic agent, colorant (e.g., pigment and/or dye), or a combination thereof.

Thermoplastic compositions comprising the polycarbonate can be manufactured by various methods. For example, the polycarbonate and other polymers (if present), and/or other optional components are first blended, optionally with fillers in a HENSCHEL-Mixer® high speed mixer. Other low shear processes, including but not limited to hand mixing, can also accomplish this blending. The blend is then fed into the throat of a twin-screw extruder via a hopper. Alternatively, at least one of the components can be incorporated into the composition by feeding directly into the extruder at the throat and/or downstream through a sidestuffer. Additives can also be compounded into a masterbatch with a desired polymeric resin and fed into the extruder. The extruder is generally operated at a temperature higher than that necessary to cause the composition to flow. The extrudate is immediately quenched in a water batch and pelletized. The pellets, so prepared, when cutting the extrudate can be one-fourth inch long or less as desired. Such pellets can be used for subsequent molding, shaping, or forming.

In various aspects, the homo and copolycarbonates can be used in making various articles including, but not limited to a film, a sheet, an optical wave guide, a display device and a light emitting diode prism. Furthermore the polycarbonates can be used in making articles such as, exterior body panels and parts for outdoor vehicles and devices including automobiles, protected graphics such as signs, outdoor enclosures such as telecommunication and electrical connection boxes, and construction applications such as roof sections, wall panels and glazing. Multilayer articles made of the disclosed polycarbonates particularly include articles which will be exposed to UV-light, whether natural or artificial, during their lifetimes, and most particularly outdoor articles; i.e., those intended for outdoor use. Suitable articles are exemplified by automotive, truck, military vehicle, and motorcycle exterior and interior components, including panels, quarter panels, rocker panels, trim, fenders, doors, decklids, trunklids, hoods, bonnets, roofs, bumpers, fascia, grilles, minor housings, pillar appliques, cladding, body side moldings, wheel covers, hubcaps, door handles, spoilers, window frames, headlamp bezels, headlamps, tail lamps, tail lamp housings, tail lamp bezels, license plate enclosures, roof racks, and running boards; enclosures, housings, panels, and parts for outdoor vehicles and devices; enclosures for electrical and telecommunication devices; outdoor furniture; aircraft components; boats and marine equipment, including trim, enclosures, and housings; outboard motor housings; depth finder housings, personal water-craft; jet-skis; pools; spas; hot-tubs; steps; step coverings; building and construction applications such as glazing, roofs, windows, floors, decorative window furnishings or treatments; treated glass covers for pictures, paintings, posters, and like display items; wall panels, and doors; protected graphics; outdoor and indoor signs; enclosures, housings, panels, and parts for automatic teller machines (ATM); enclosures, housings, panels, and parts for lawn and garden tractors, lawn mowers, and tools, including lawn and garden tools; window and door trim; sports equipment and toys; enclosures, housings, panels, and parts for snowmobiles; recreational vehicle panels and components; playground equipment; articles made from plastic-wood combinations; golf course markers; utility pit covers; computer housings; desk-top computer housings; portable computer housings; lap-top computer housings; palm-held computer housings; monitor housings; printer housings; keyboards; facsimile machine housings; copier housings; telephone housings; mobile phone housings; radio sender housings; radio receiver housings; light fixtures; lighting appliances; network interface device housings; transformer housings; air conditioner housings; cladding or seating for public transportation; cladding or seating for trains, subways, or buses; meter housings; antenna housings; cladding for satellite dishes; coated helmets and personal protective equipment; coated synthetic or natural textiles; coated photographic film and photographic prints; coated painted articles; coated dyed articles; coated fluorescent articles; coated foam articles; and like applications.

In another aspect, the polycarbonate material of the present invention can comprise a blend of polycarbonate and at least one other polymeric material. In one aspect, the polycarbonate itself can comprise a mixture or blend of polycarbonate materials In one aspect, the polycarbonate can comprise one or more other polymers, such as, for example, an acrylonitrile-butadiene-styrene. In another aspect, the one or more other polymeric materials mixed and/or blended with a polycarbonate can comprise a polymer system capable of maintaining and/or improving the heat deflection temperature of the resulting material. One of skill in the art, in possession of this disclosure, could readily select an appropriate polycarbonate and/or polycarbonate blend material.

In another aspect, the first polymer component can silicone-polycarbonate copolymer in addition to or in lieu of a polycarbonate. If present, a silicone-polycarbonate can comprise any copolymer of a siloxane compound and a polycarbonate. In one aspect, a silicone-polycarbonate can comprise a polysiloxane-polycarbonate copolymer (PC-ST), wherein the dimethylsiloxane content in the copolymer is about 20 wt. %. In other aspects, the relative amounts of siloxane and polycarbonate in a copolymer, if present, can vary, and the present invention is not intended to be limited to any particular ratio of siloxane and polycarbonate. Polycarbonate materials and silicone-polycarbonate copolymer materials are commercially available, and one of skill in the art, in possession of this disclosure, could readily select an appropriate first polymer component.

### Fine Silica

The fine silica of the inventive composition can comprise any particulate silica suitable for use in the inventive composition or for an intended application. In various aspects, the fine silica can comprise a fumed silica, a precipitated silica, and/or other particulate silica material. In another aspect, the inventive composition comprises a fumed silica. In another aspect, the method of manufacture for the silica material is not limited to any particular method.

The fine silica can have any particle size of distribution of particle sizes suitable for use in the inventive composition. In one aspect, the fine silica can have an average particle size of less than about 100 nm, for example, less than 100 nm, less than 80 nm, less than 60 nm, less than 40 nm, or less than 20 nm. In another aspect, the fine silica can have an average particle size of from about 5 nm to about 25 nm, for example, about 5, 6, 7, 8, 9, 10, 11, 12, 13, 14, 15, 16, 17, 18, 19, 20, 21, 22, 23, 24, or 25 nm. In yet another aspect, the fine silica can have an average particle size of from about 10 nm to about 14 nm, for example, about 10, 11, 12, 13, or 14 nm. In a specific aspect, the fine silica can have an average particle size of about 12 nm. It should be appreciated that fine silica materials are particulate and have distributional properties. As such, the average particle size and distribution of particle sizes within a given sample can vary, and the present invention is not intended to be limited to any particular size or distribution of particle sizes.

The surface chemistry of a fine silica can similarly comprise any suitable surface chemistry for use with the flame retardant composition of the present invention. In one aspect, the surface of at least a portion of the fine silica can be unmodified. In another aspect, the surface of at least a portion of the fine silica can comprise trimethly functional groups. In an exemplary aspect, the inventive composition comprises AEROSIL RX200 hydrophobic silica, available from EVONIK. In yet another aspect, the surface of at least a portion of the fine silica can comprise silanol functional groups. In an exemplary aspect, the inventive composition comprises AEROSIL 200 hydrophilic fumed silica, available from EVONIK. In still other aspects, the surface of all or a portion of the fine silica can comprise other functional groups and/or a mixture of various functional groups. The surface of a fine silica, if modified, can comprise any concentration of functional groups, such as, for example, from about 0 wt. % to about 100 wt. %, for example, 0, 5, 10, 15, 20, 25, 30, 35, 40, 45, 50, 55, 60, 65, 70, 75, 80, 85, 90, 95, or 100 wt. %. In another aspect, the surface of a fine silica, if modified, can comprise at least about 80% of a desired functional group, such as, for example, trimethyl functional groups.

In various aspects, the present inventive composition can comprise any amount of fine silica appropriate for use in an intended application. In various aspects, the inventive composition can comprise from about 0.1 wt. % to about 15 wt. %, for example, 0.1, 0.3, 0.5, 0.7, 0.9, 1, 2, 3, 4, 5, 6, 7, 8, 9, 10, 11, 12, 13, 14, or 15 wt. % fine silica. In another aspect, the inventive composition can comprise from about 0.3 wt. % to about 2 wt. %, for example, about 0.3, 0.4, 0.5, 0.6, 0.7, 0.8, 0.9, 1, 1.1, 1.2, 1.3, 1.4, 1.5, 1.6, 1.7, 1.8, 1.9, or 2 wt. % of fine silica. In other aspects, the inventive composition can comprise less than about 0.3 wt. % or greater than about 2 wt. % of fine silica and the present invention is not intended to be limited to any particular fine silica concentration. Fine silica materials are commercially available, and one of skill in the art, in possession of this disclosure, could readily select an appropriate fine silica.

### Second Polymer Component

The inventive composition also comprises a second polymer component. In various aspects, the second polymer component can comprise a single polymer, a copolymer, or a mixture of polymers. In one aspect, the second polymer component comprises an acrylonitrile-butadiene-styrene (ABS) polymer. In another aspect, the second polymer component comprises an acrylonitrile-ethylene-styrene (AES) polymer. In yet another aspect, the second polymer component comprises a poly(methylmethacrylate) (PMMA) polymer. In still other aspects, the second polymer component can comprise a mixture of any two or more individual polymers.

The second polymer component can be present in any amount suitable for an inventive composition or for an intended application. In one aspect, the inventive composition comprises from about 10 wt. % to about 25 wt. % of the second polymer component, for example, about 10, 11, 12, 13, 14, 15, 16, 17, 18, 19, 20, 21, 22, 23, 24, or 25 wt. % of the second polymer component. In another aspect, the inventive composition can comprise from about 15 wt. % to about 18.5 wt. %, for example, about 15, 15.5, 16, 16.5, 17, 17.5, 18, or 18.5 wt. % of the second polymer component.

In one aspect, the inventive composition comprises about 15 wt. % of AES. In another aspect, the inventive composition comprises about 15 wt. % ABS. In yet another aspect, the inventive composition comprises about 15 wt. % PMMA. In another aspect, the inventive composition comprises about 5 wt. % ABS and about 13.5 wt. % PMMA. In still another aspect, the inventive composition comprises about 5 wt. % AES and about 13.5 w.t % PMMA. In other aspects, the inventive composition can comprise less than about 10 wt. % or greater than about 25 wt. % of the second polymer component, and the present invention is not intended to be limited to any particular concentration of the second polymer component. Second polymer components, such as, for example, ABS, AES, and PMMA, are commercially available, and one of skill in the art could readily select an appropriate second polymer component.

### Flame Retardant Additive

The inventive composition comprises a flame retardant additive. In various aspects, the flame retardant additive can comprise any flame retardant material or mixture of flame retardant materials suitable for use in the inventive composition. In one aspect, the flame retardant additive comprises bisphenol A diphenyl phosphate (BPADP). In another aspect, the flame retardant additive comprises a phosphate containing material. In another aspect, the flame retardant additive comprises a halogen containing material. In other aspects, the flame retardant additive is free of or substantially free of one or more of phosphate and/or a halogen.

The concentration of a flame retardant additive can vary, and the present invention is not intended to be limited to any particular flame retardant concentration. In one aspect, the inventive composition comprises from about 5 wt. % to about 30 wt. % of flame retardant additive, for example, about 5, 6, 7, 8, 9, 10, 11, 12, 13, 14, 15, 16, 17, 18, 19, 20, 22, 24, 26, 28, or 30 wt. %. In other aspects, the inventive composition comprises from about 10 wt. % to about 15 wt. % of flame retardant additive, for example, about 10, 10.5, 11, 11.5, 12, 12.5, 13, 13.5, 14, 14.5, or 15 wt. %. In a specific aspect, the inventive composition comprises about 13.5 wt. % flame retardant additive, such as, BPADP. Flame retardant additives are commercially available, and one of skill in the art could readily select an appropriate flame retardant additive.

### Additives

In other aspects, the inventive composition can comprise one or more other materials that can maintain and/or improve various properties of the resulting material. In various aspects, the inventive polycarbonate can comprise an impact modifier, epoxy, anti-drip agent, filler, other additives, or a combination thereof. The inventive composition can be transparent or have any degree of color and/or opacity as required for an intended application. Each of the materials recited herein as potential components of an inventive composition are commercially available and/or can be produced by those of skill in the art.

In one aspect, the inventive composition comprises from about 0.5 wt. % to about 99.5 wt. % of a first polymer component, such as, for example, a polycarbonate and/or silicone-polycarbonate copolymer, a fine silica having an average particle size of less than about 100 nm, from about 0 wt. % to about 30 wt. % of a second polymer component, such as, for example, ABS, AES, PMMA, or a combination thereof, and from about 0.5 wt. % to about 25 wt. % of a flame retardant additive.

In another aspect, the inventive composition comprises from about 0.5 wt. % to about 99.5 wt. % of a first polymer component, such as, for example, a polycarbonate and/or silicone-polycarbonate copolymer, a fine silica having an average particle size of about 12 nm and having about 80% surface coverage of trimethyl functional groups, from about 0 wt. % to about 30 wt. % of a second polymer component, such as, for example, ABS, AES, PMMA, or a combination thereof, and from about 0.5 wt. % to about 25 wt. % of a flame retardant additive. In one aspect, the inventive composition does not comprise and/or can achieve the properties recited herein in the absence of a glass fiber or carbon fiber, an alkaline earth metal salt, sulfonic alkaline metal salt, or sulphuric alkaline metal salt. In another aspect, the inventive composition does not comprise an aryl ethylene styrene.

### Properties of Flame Retardant Polycarbonate Composition

The inventive composition has flame retardant properties and a balance of impact resistance, heat resistance, and pencil hardness. In one aspect, the inventive composition has a flame retardancy rating of V0 at a thickness of at least about 1.5 mm, according to UL94 standards. In another aspect, the inventive composition has a flame retardancy rating of V0 at a thickness of up to about 1.7 mm.

In one aspect, the flame retardancy of a material can be determined using standardized test criteria, such as, for example, UL 94 tests. Thin articles present a particular challenge in the UL 94 tests, because compositions suitable for the manufacture of thin articles tend to have a higher flow.

Shaped, formed, or molded articles comprising the thermoplastic compositions are also provided. The thermoplastic compositions can be molded into useful shaped articles by a variety of means such as injection molding, extrusion, rotational molding, blow molding and thermoforming to form articles such as, for example, computer and business machine housings such as housings for monitors, hand held electronic device housings such as housings for cell phones, electrical connectors, and components of lighting fixtures, ornaments, home appliances, roofs, greenhouses, sun rooms, swimming pool enclosures, and the like. The above-described compositions are of particular utility in the manufacture of articles comprising a minimum wall thickness of as low as about 0.1 mm, 0.5 mm, 1.0 mm, or 2.0 mm (about indicating ±10%). The above-described compositions are also of particular utility in the manufacture of articles comprising a minimum wall thickness of about 3 mm or less, e.g., about 0.1 mm to about 2 mm, e.g., about 1.2 mm to about 2 mm, or about 0.2 mm to about 1.8 mm or, more specifically, about 0.6 mm to about 1.5 mm or about 0.8 mm to about 1.2 mm.

Flammability tests were performed following the procedure of Underwriter's Laboratory Bulletin 94 entitled “Tests for Flammability of Plastic Materials, UL94.” According to this procedure, materials can be classified as HB, V0, UL94 V1, V2, 5VA, and/or 5VB on the basis of the test results obtained for five samples. The criteria for each of these flammability classifications are described below and elsewhere herein.

V0: In a sample placed so that its long axis is 180 degrees to the flame, the period of flaming and/or smoldering after removing the igniting flame does not exceed ten seconds and the vertically placed sample produces no drips of burning particles that ignite absorbent cotton.

V1: In a sample placed so that its long axis is 180 degrees to the flame, the period of flaming and/or smoldering after removing the igniting flame does not exceed thirty seconds and the vertically placed sample produces no drips of burning particles that ignite absorbent cotton.

V2: In a sample placed so that its long axis is 180 degrees to the flame, the average period of flaming and/or smoldering after removing the igniting flame does not exceed twenty-five seconds, but the vertically placed samples produce drips of burning particles that ignite cotton. Five bar flame out time is the sum of the flameout time for five bars, each lit twice for a maximum flame out time of 250 seconds.

5VB: a flame is applied to a vertically fastened, 5-inch (127 mm) by 0.5-inch (12.7 mm) test bar of a given thickness above a dry, absorbent cotton pad located 12 inches (305 mm) below the bar. The thickness of the test bar is determined by calipers with 0.1 mm accuracy. The flame is a 5-inch (127 mm) flame with an inner blue cone of 1.58 inches (40 mm). The flame is applied to the test bar for 5 seconds so that the tip of the blue cone touches the lower corner of the specimen. The flame is then removed for 5 seconds. Application and removal of the flame is repeated for until the specimen has had five applications of the same flame. After the fifth application of the flame is removed, a timer (T-0) is started and the time that the specimen continues to flame (after-flame time), as well as any time the specimen continues to glow after the after-flame goes out (after-glow time), is measured by stopping T-0 when the after-flame stops, unless there is an after-glow and then T-0 is stopped when the after-glow stops. The combined after-flame and after-glow time must be less than or equal to 60 seconds after five applications of a flame to a test bar, and there can be no drips that ignite the cotton pad. The test is repeated on 5 identical bar specimens. If there is a single specimen of the five does not comply with the time and/or no-drip requirements then a second set of 5 specimens are tested in the same fashion. All of the specimens in the second set of 5 specimens must comply with the requirements in order for material in the given thickness to achieve the 5VB standard.

Time to drip: The time to drip is determined by alternately applying and removing a flame as described for the 5VB test in consecutive 5-second intervals, until the first drip of material falls from the bar. A time to drip characteristic of 55 seconds (s) or greater has been found to correlate well with other desired characteristics such as 5VB ratings.

Flame retardancy can also be analyzed by calculation of the average flame out time, standard deviation of the flame out time, as the total number of drips, and using statistical methods to convert that data to a prediction of the probability of first time pass, or “pFTP”, that a particular sample formulation would achieve a V0 “pass” rating in the conventional UL94 testing of 5 bars. Preferably pFTP will be as close to 1 as possible, for example greater than 0.9 and more preferably greater than 0.95, for maximum flame-retardant performance in UL testing. A pFTP of 0.85 or greater is deemed to be successful.

In another aspect, the inventive composition has a notched IZOD impact rating of at least about 30, at least about 40, at least about 60, at least about 80, at least about 100, or at least about 110 J/m. In another aspect, the inventive composition has a notched IZOD impact rating of at least about 80 J/m.

In another aspect, the inventive composition has a heat deflection temperature of at least about 80° C., at least about 84° C., at least about 85° C., or at least about 86° C.

The inventive composition also exhibits improved pencil hardness as compared to existing flame retardant polycarbonate compositions. Pencil hardness is a measure of the hardness of a material on a scale ranging from 9H (hardest) to 9B (softest). In general, the pencil hardness scale is 9H (hardest), 8H, 7H, 6H, 5H, 4H, 3H, 2H, H, F, HB (medium), B, 2B, 3B, 4B, 5B, 6B, 7B, 8B, and 9B (softest), for example, at 700 g. In one aspect, the inventive composition has a pencil hardness equal to or greater than (i.e., harder than) B, for example, B, HB, F, H, 2H, 3H, 4H, 5H, 6H. 7H, 8H, or 9H. In another aspect, the inventive composition has a pencil hardness equal to or greater than HB. In yet another aspect, the inventive composition has a pencil hardness equal to or greater than F.

In one aspect, the inventive composition has a flame retardancy of V0 at a thickness of at least 1.5 mm, a notched IZOD impact rating of at least about 110 J/m, a heat deflection temperature of at least about 86° C., and a pencil hardness of at least about B at 700 g.

In one aspect, the inventive composition has a flame retardancy of V0 at a thickness of at least 1.5 mm, a notched IZOD impact rating of at least about 80 J/m, a heat deflection temperature of at least about 85° C., and a pencil hardness of at least about F at 700 g.

In one aspect, the inventive composition has a flame retardancy of V0 at a thickness of at least 1.5 mm, a notched IZOD impact rating of at least about 80 J/m, a heat deflection temperature of at least about 85° C., and a pencil hardness of at least about HB at 700 g.

In one aspect, the inventive composition has a flame retardancy of V0 at a thickness of at least 1.5 mm, a notched IZOD impact rating of at least about 30 J/m, a heat deflection temperature of at least about 86° C., and a pencil hardness of at least about H at 700 g.

In one aspect, the inventive composition has a flame retardancy of V0 at a thickness of at least 1.5 mm, a notched IZOD impact rating of at least about 40 J/m, a heat deflection temperature of at least about 85° C., and a pencil hardness of at least about H at 700 g.

In one aspect, the inventive composition has a flame retardancy of V0 at a thickness of at least 1.5 mm, a notched IZOD impact rating of at least about 60 J/m, a heat deflection temperature of at least about 84° C., and a pencil hardness of at least about H at 700 g.

In one aspect, the inventive composition has a flame retardancy of V0 at a thickness of at least 1.5 mm, a notched IZOD impact rating of at least about 30 J/m, a heat deflection temperature of at least about 85° C., and a pencil hardness of at least about H at 700 g.

In one aspect, the inventive composition has a flame retardancy of V0 at a thickness of at least 1.5 mm, a notched IZOD impact rating of at least about 60 J/m, a heat deflection temperature of at least about 84° C., and a pencil hardness of at least about F at 700 g.

While typical aspects have been set forth for the purpose of illustration, the foregoing descriptions should not be deemed to be a limitation on the scope of the invention. Accordingly, various modifications, adaptations, and alternatives can occur to one skilled in the art without departing from the spirit and scope of the present invention.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

Notched Izod impact (N11) strength was performed according to ASTM D256 procedures. Analysis was performed on at least five bars for each formulation, using a Ceast instrument with a 2.75 J hammer.

The flammability of each test bar was also determined using UL94 flame testing procedures in a closed chamber (Atlas HVUL cabinet) and with a methane gas supply. Samples were conditioned for 48 hours at 23° C. and 50% relative humidity prior to testing.

1. Comparative Samples

In a first example, several comparative samples (C1-C8) were prepared as illustrated in Table 2, below. The resulting properties, including flame retardancy, pencil hardness, heat deflection temperature, and impact resistance are also detailed in Table 2.

TABLE 2
Comparative Examples

| Properties | | C1 | C2 | C3 | C4 | C5 | C6 | C7 | C8 |
|---|---|---|---|---|---|---|---|---|---|
| | PC | 70.45 | 70.45 | 70.45 | 70.45 | 68.45 | 64.95 | 56.95 | 68.45 |
| | A200 | 0 | 0 | 0 | 0 | 2 | 2 | 2 | |
| | RX200 | | | | | | | | 2 |
| | AES | 15 | | | | | | | |
| | ABS | | 15 | | | | | | 15 |
| | PMMA | | | 15 | | | 13.5 | 13.5 | |
| | MBS | | | | 15 | 15 | 5 | 5 | |
| | Si-PC | | | | | | | 8 | |
| | copolymer | | | | | | | | |
| | BPADP | 13.5 | 13.5 | 13.5 | 13.5 | 13.5 | 13.5 | 13.5 | 13.5 |
| | Additives | 1.05 | 1.05 | 1.05 | 1.05 | 1.05 | 1.05 | 1.05 | 1.05 |
| | Unit | | | | | | | | |
| UL 94 | 1.5 mm | V0 | V0 | V2 | V2 | V1 | No V | No V | V0 |
| rating | | | | | | | | | |
| Pencil | 3B, | 2B | 3B | HB | 3B | 2B | F | F | 3B |
| hardness@ | 2B, B, HB, | | | | | | | | |
| 700 g | F, H | | | | | | | | |
| HDT | Deg. C. | 86 | 86 | 86 | 85 | 85 | 85 | 84 | 85 |
| IZOD | Mpa | 90 | 100 | 30 | 300 | 200 | 30 | 100 | 200 |
| impact | | | | | | | | | |

As illustrated in Table 2, the comparative examples do not exhibit the desired balance of impact resistance, heat resistance, flame retardancy, and pencil hardness, as described for the inventive compositions.

2. Inventive Samples

In a second example, several inventive samples were prepared as described in the specification and in Table 3, below. The resulting properties of each of the inventive samples are also detailed in Table 3.

TABLE 3
Inventive Samples

| Properties | | 1 | 2 | 3 | 4 | 5 | 6 | 7 | 8 | 9 |
|---|---|---|---|---|---|---|---|---|---|---|
| | PC | 70.15 | 70.15 | 68.45 | 68.45 | 65.45 | 64.95 | 56.95 | 64.95 | 56.95 |
| | A200 | 0.3 | 0.3 | 2 | 2 | 2 | 2 | 2 | 2 | 2 |
| | RX200 | | | | | | | | | |
| | AES | 15 | | 15 | | | 5 | 5 | | |
| | ABS | | 15 | | 15 | | | | 5 | 5 |
| | PMMA | | | | | 15 | 13.5 | 13.5 | 13.5 | 13.5 |
| | MBS | | | | | | | | | |
| | Si-PC | | | | | | | 8 | | 8 |
| | copolymer | | | | | | | | | |
| | BPADP | 13.5 | 13.5 | 13.5 | 13.5 | 13.5 | 13.5 | 13.5 | 13.5 | 13.5 |
| | Additives | 1.05 | 1.05 | 1.05 | 1.05 | 1.05 | 1.05 | 1.05 | 1.05 | 1.05 |
| | Unit | | | | | | | | | |
| UL 94 | 1.5 mm | V0 | V0 | V0 | V0 | V0 | V0 | V0 | V0 | V0 |
| rating | | | | | | | | | | |
| Pencil | 3B, | HB | B | F | HB | H | H | H | H | F |
| hardness | 2B, B, HB, | | | | | | | | | |
| @700 g | F, H | | | | | | | | | |
| HDT | Deg. C. | 85 | 86 | 85 | 85 | 86 | 85 | 84 | 85 | 84 |
| IZOD | Mpa | 100 | 110 | 80 | 80 | 30 | 40 | 60 | 30 | 60 |
| impact | | | | | | | | | | |

As illustrated in Table 3, the inventive examples exhibit a desired balance of impact resistance, heat resistance, flame retardancy, and pencil hardness, as described in the specification.

It will be apparent to those skilled in the art that various modifications and variations can be made in the present invention without departing from the scope or spirit of the invention. Other aspects of the invention will be apparent to those skilled in the art from consideration of the specification and practice of the invention disclosed herein. It is intended that the specification and examples be considered as exemplary only, with a true scope and spirit of the invention being indicated by the following claims.

1. A composition comprising:
a) from about 0.5 wt. % to about 99.5 wt. % of a first polymer component comprising a polycarbonate, a silicone-polycarbonate copolymer, or a combination thereof;
b) a fine silica;
c) from about 0 wt. % to about 30 wt. % of a second polymer component comprising an acrylonitrile-butadiene-styrene, an acrylonitrile-ethylene-styrene, a poly(methylmethacrylate), or a combination thereof; and
d) from about 0.5 wt. % to about 25 wt. % of a flame retardant additive,
wherein the composition has a notched IZOD impact rating of at least 80 J/m.

2. The composition of claim 1, wherein the first polymer component comprises polycarbonate.

3. The composition of claim 1, wherein the first polymer comprises a silicone-polycarbonate copolymer.

4. The composition of claim 1, comprising from about 50 wt. % to about 75 wt. % of the first polymer component.

5. The composition of claim 1, wherein the fine silica comprises a fumed silica.

6. The composition of claim 1, wherein the fine silica has an average particle size of less than about 100 nm.

7. The composition of claim 1, wherein the fine silica has an average particle size of about 12 nm.

8. The composition of claim 1, wherein at least a portion of the fine silica comprises trimethyl functional groups disposed on a surface thereof.

9. The composition of claim 1, comprising from about 0.3 wt. % to about 2 wt. % fine silica.

10. The composition of claim 1, wherein the second polymer component comprises acrylonitrile-butadiene-styrene.

11. The composition of claim 10, wherein the second polymer component further comprises poly(methylmethacrylate).

12. The composition of claim 1, wherein the second polymer component comprises acrylonitrile-ethylene-styrene.

13. The composition of claim 12, wherein the second polymer component further comprises poly(methylmethacrylate).

14. The composition of claim 1, comprising from about 15 wt. % to about 18.5 wt. % of the second polymer component.

15. The composition of claim 1, wherein the flame retardant additive comprises bisphenol a diphosphate.

16. The composition of claim 1, having a flame retardancy rating of V0 at a thickness of up to 1.7 mm and having a pencil hardness of B or harder at 700 g.

17. The composition of claim 1, having a flame retardancy rating of V0 at a thickness of up to 1.7 mm, a notched IZOD impact rating of at least 80 J/m, a heat deflection temperature of at least about 85° C., and a pencil hardness of HB or harder at 700 g.

18. The composition of claim 17, wherein the impact rating is at least 100 J/m.

19. A method for preparing a flame resistant polycarbonate composition, the method comprising: contacting from about 0.5 wt. % to about 99.5 wt. % of a first polymer component comprising a polycarbonate, a silicone-polycarbonate copolymer, or a combination thereof; a fine silica; from about 0 wt. % to about 30 wt. % of a second polymer component comprising an acrylonitrile-butadiene-styrene, an acrylonitrile-ethylene-styrene, a poly(methylmethacrylate), or a combination thereof; from about 0.5 wt. % to about 25 wt. % of a flame retardant additive.

20. The method of claim 19, wherein at least a portion of the fine silica comprises trimethyl functional groups disposed on a surface thereof.
